(19) United States
(12) Patent Application Publication
(10) Pub. No.: US 2023/0332948 A1
(43) Pub. Date: Oct. 19, 2023

(54) DYNAMIC RANGE EXTENSION OF SPAD-BASED DEVICES

(71) Applicant: ams International AG, JONA (CH)

(72) Inventors: André VAN DER AVOIRD, AE Eindhoven (NL); Bobby DANIEL, JJ Eindhoven (NL); Erik JAN LOUS, KE Veldhoven (NL); Jagruth PRASANNA KUMAR, AK Geldrop (NL)

(73) Assignee: ams International AG, JONA (CH)

(21) Appl. No.: 18/043,081

(22) PCT Filed: Aug. 26, 2021
(86) PCT No.: PCT/EP2021/073647

§ 371 Date: Feb. 27, 2023

(30) Foreign Application Priority Data
Aug. 28, 2020 (GB) 2013569.5

(51) Int. Cl. G01J 1/44

(52) U.S. Cl. CPC G01J 1/44; G01J 2001/4466; G01J 2001/448

(57) ABSTRACT

A radiation-sensitive device is disclosed. The device includes an array of single photon avalanche diodes (SPADs) and circuitry configured to measure an intensity of incident radiation from the array of SPADs with a plurality of different measurement windows to provide an associated plurality of results. The circuitry is configured to determine the intensity of the incident radiation from one of the plurality of results, a selection of the result determined by whether the result exceeds a maximum count defined, at least in part, by a duration of the measurement window associated with the result. An associated method of increasing a dynamic range of a radiation-sensitive device comprising an array of SPADs is also disclosed.

### CROSS-REFERENCE TO RELATED APPLICATIONS

The present application is the national stage entry of International Patent Application No. PCT/EP2021/073647, filed on Aug. 26, 2021, and published as WO 2022/043456 A1 on Mar. 3, 2022, which claims the benefit of priority of Great Britain Patent Application No. 2013569.5, filed on Aug. 28, 2020, the disclosures of all of which are incorporated by reference herein in their entireties.

### TECHNICAL FIELD

The present disclosure is in the field of SPAD-based devices for use in measurements requiring a large dynamic ranges, such as point of care testing, electronic-nose applications, and ambient radiation sensing.

### BACKGROUND

Detection of radiation emission with a large Dynamic Range (DR) is required in the field of luminescence and fluorescence radiation sensors. Such sensors may, for example, be used in Point of Care (PoC) testing or Electronic-Nose (E-nose) type of applications, or ambient radiation sensor applications.

In the PoC applications, the presence of biological or chemical substances in fluids or air may be detected by their interaction with complementary substances, which may result in chemi-luminescent or fluorescent radiation emission. The levels of the radiation emitted may dynamically vary between extremely low and high levels. To enable a complete signal capture, a radiation sensor suitable for use in such an application must exhibit a very high dynamic range.

Single Photon Avalanche Diode (SPAD) based photon counters offer the ability to detect very low levels of radiation by counting individual photons. The lowest level of detectable signal may be limited by noise due to a dark-count-rate (DCR). The highest level of detectable signal may be limited by the speed of the SPAD diode itself, by a capacity of a counter associated with the SPAD, and/or by capabilities of associated circuitry. In some applications, this may limit a dynamic range of a SPAD-based sensor.

Some sensor implementations may comprise a large amount of SPADs in order to improve a signal-to-noise ratio at low radiation levels. However, such a large amount of SPADs may result in an increase in associated circuitry, potentially further limiting an achievable dynamic range.

In other prior art sensor implementations, different SPAD areas may be used within a single device in combination with one or more pinholes, in order to adjust a radiation intensity incident upon the different SPAD areas. For example, stacked pin-holes with shifted apertures in a black medium may be implemented to reduce an intensity of incident radiation. Sensors implementing such solutions may be large, may require additional components, and may exhibit a relatively poor signal-to-noise ratio.

It is therefore desirable to provide a radiation sensor having a large dynamic range suitable for PoC testing or E-nose applications, without compromising on signal-to-noise ratio, or requiring additional components or requiring a substantial increase in device size.

It is therefore an aim of at least one embodiment of at least one aspect of the present disclosure to obviate or at least mitigate at least one of the above identified shortcomings of the prior art.

### SUMMARY

The present disclosure is in the field of SPAD-based devices, and in particular relates to SPAD-based devices with large dynamic ranges suitable for use in Point of Care testing,Electronic-Nose applications, and ambient radiation sensing applications.

According to a first aspect of the disclosure, there is provided a radiation-sensitive device comprising an array of single photon avalanche diodes (SPADs) and circuitry configured to measure an intensity of incident radiation from the array of SPADs with a plurality of different measurement windows to provide an associated plurality of results. The circuitry is configured to determine the intensity of the incident radiation from one of the plurality of results, a selection of the result determined by whether the result exceeds a maximum count defined, at least in part, by a duration of the measurement window associated with the result.

Advantageously, by using a plurality of different measurement windows, i.e. measurement time windows, a plurality of different measurements of the intensity of incident radiation may be made, wherein a signal-to-noise ratio of each measurement may differ, at least in part, according to the duration of the measurement window. As described in more detail below a portion of the measurement period associated with each measurement window may also be selected. The combination of the measurement window and the duration of a portion of a measurement period may determine an overall signal-to-noise ratio of a given measurement. Furthermore, by using a relatively short measurement window, a relatively high intensity of incident radiation may be measured and by using a relatively long measurement window a relatively low intensity of incident radiation may be measured. Measurements using such different measurement windows may extend an effective dynamic range of the radiation-sensitive device. In addition, it has been recognised that at relatively high intensities of incident radiation, there is sufficient signal strength that a low signal-to-noise measurement may suffice. As such, a result from the plurality of results may be selected based on an intensity of the incident radiation, effectively trading off an achievable signal-to-noise ratio for dynamic range, on the premise that a high signal-to-noise ratio capabilities may not required at relatively high intensities of incident radiation.

That is, beneficially an amount of time a given SPAD of the plurality of SPADs has available to detect a photon strike may be predefined according to defined signal-to-noise ratio and dynamic range requirements.

Since each SPAD may only record a single photon-strike event between each read-out cycle, having for example a relatively long measurement window during a period of relatively high intensity incident radiation may result in a substantial amount of the plurality of SPADs not recording photon-strikes events, limiting a radiation intensity that can be measured. By having a measurement period divided into portions with measurement windows in relation to the intensity of the incident radiation, an amount of SPADs that are not recording photon-strikes events may be minimised, and hence a dynamic range of the radiation-sensitive device may be increased, while maintaining an adequate signal-to-noise ratio.

The maximum count may be defined by the duration of the measurement window associated with the result and a read-out rate of the SPADs.

For example, for a SPAD array comprising 100 SPADs, and a read-out rate of 10 MHz, a maximum of 100,000 counts per second per SPAD may be made. A duration of the measurement window may correspond to a scaling factor applied to the maximum count, as described in more detail below.

The circuitry may be configured to scale at least one result with a corresponding weighting factor, a magnitude of the weighting factor corresponding to the duration of the measurement window associated with the result.

Continuing with the previous example, if a duration of portion of a 1 second measurement period is 0.9 s, then a measured count may be scaled by a weighting factor of ⅟0.9 to provide the maximum count of 100,000.

A duration of the measurement window in each consecutive portion of a measurement period may vary by a factor of four. For example, a duration of the measurement window in each consecutive portion of a measurement period may be increased or decreased by a factor of four. A duration of the measurement window in each consecutive portion of a measurement period may be increased or decreased by a factor of four for every factor of two increase in a signal, e.g. an increase in an intensity of the incident radiation.

The circuitry may be configured to configure the array of SPADs to measure the incident radiation with a relatively short measurement window for a smaller portion of a/the measurement period than a portion of the measurement period that the array of SPADs measures the incident radiation with a relatively long measurement window.

Advantageously, a duration of a portion of a measurement period with relatively short measurement windows may be reduced as a signal strength increases, e.g. as an intensity of incident radiation increases. Similarly, at low signal levels, e.g. at a low intensity of incident radiation, a larger portion of the measurement period comprising longer measurement windows may be needed to ensure a sufficient signal-to-noise ratio.

A duration of each measurement window may be programmable.

A duration of each portion of a/the measurement period may be programmable.

Advantageously, the duration of the measurement window and/or each portion of the measurement period may be defined by one or more user-programmable fields, thus enabling a programmable trade-off between dynamic range and achievable signal-to-noise ratio. For example, the device may have one or more programmable registers for defining one or more of the durations and/or one or more read-out rates.

A duration of the measurement window may be different in each portion of the measurement period.

Each SPAD of the plurality of SPADs may have an associated single-bit counter for registering photon strikes.

Advantageously, an overall size of the radiation-sensitive device may be minimised by associating only a single-bit counter with each SPAD. An alternative architecture which may employ multi-bit counters per SPAD to minimise the likelihood of missed photon-strike events may incur costs associated with larger overall device area.

It will be understood that a single-bit counter may be a latch, or switch. That is, in some embodiments the single-bit counter may be one or more circuit components configured to record an event, e.g. latch a signal. Such an single-bit counter may be cleared, e.g. reset, at a rate defined by the read-out rate of the SPADs.

Furthermore, the term “read-out” will be understood to correspond to a process of determining whether the single-bit counter is set, e.g. the latch has latched a photon-strike event. For example, reading-out an array of SPADs would comprise circuitry determining which of the counters associated with the SPADs have counted, e.g. latched, a photon strike event.

The read-out rate may be dependent upon an amount of SPADs that are to be read-out.

According to a second aspect of the disclosure, there is provided a method of increasing a dynamic range of a radiation-sensitive device comprising an array of SPADs. The method comprises a step of measuring an intensity of incident radiation from the array of SPADs with a plurality of different measurement windows to provide an associated plurality of results. The method comprises a step of determining the intensity of the incident radiation from one of the plurality of results, a selection of the result determined by whether the result exceeds a maximum count defined, at least in part, by a duration of the measurement window associated with the result.

The method may comprise a step of selecting and/or programming a duration of each measurement window of the plurality of measurement windows.

The step of measuring the intensity of incident radiation from the array of SPADs with a plurality of different measurement windows may comprise using a relatively short measurement window for a smaller portion of a measurement period than a portion of the measurement period having a relatively long measurement window.

The method may comprise a step of selecting and/or programming a duration of a portion of the measurement period associated with each measurement window.

According to a third aspect of the disclosure, there is provided a use of a radiation-sensitive device according to the first aspect in a point-of-care testing or diagnostics application, or an electronic-nose application, to determine an intensity of luminescence and/or fluorescence from a specimen.

Detection of radiation emission with a very large dynamic range is particularly required in such point-of-care testing or diagnostics applications, or electronic-nose applications, because the levels of the chemi-luminescent or fluorescent radiation emitted by interaction between biological or chemical substances and complementary substances may vary dynamically between extreme low and high levels.

According to a fourth aspect of the disclosure, there is provided an electronic-nose or point-of-care apparatus comprising a radiation-sensitive device according to the first aspect, wherein the radiation-sensitive device is configured to determine an intensity of luminescence and/or fluorescence from a specimen.

According to a fifth aspect of the disclosure, there is provided a use of a radiation-sensitive device according to the first aspect in an ambient radiation sensing application.

The radiation-sensitive device may be implemented in an imaging device such as a camera, e.g. a camera on a smartphone, for determining an ambient radiation level. The determined ambient radiation level may be used to adapt an image captured by the imaging device. The determined ambient radiation level may be used to configure the imaging device, such as to control operation of an aperture, a flash, or the like.

The radiation-sensitive device may be for determining an ambient radiation level for adjusting a brightness of a screen or display.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE DRAWINGS

These and other aspects of the present disclosure will now be described, by way of example only, with reference to the accompanying drawings, wherein:

FIG. 1 depicts a SPAD-based sensor architecture according to an embodiment of the disclosure;

FIG. 2 depicts an example measurement period of a radiation-sensitive device according to an embodiment of the disclosure;

FIG. 3 depicts a radiation-sensitive device according to an embodiment of the disclosure; and

FIG. 4 depicts a method of increasing a dynamic range of a radiation-sensitive device according to an embodiment of the disclosure.

### DETAILED DESCRIPTION OF THE PREFERRED EMBODIMENTS

It has been recognised that in some applications, to increase a signal-to-noise ratio (SNR) in SPAD-based devices, e.g. to accurately detect very low light levels, it may be beneficial to implement a substantial quantity of SPADs. That is, such devices may implement SPAD-arrays comprising, hundreds or even thousands of SPADs in order to accurately measure an intensity of incident radiation with sufficient SNR.

However, a maximum radiation intensity that can be measured by a given SPAD array may be determined by its saturation level.

Saturation may occur when a photon rate reaches a limit of the rate at which SPAD device itself can perform detection. For example, the fastest rate at which a SPAD-based device can count photon-strike events is determined by a time between a photon-strike event and a recovery time of the SPAD. The recovery time is a time required for a given SPAD to recover and be ready again. This is known in the art as the ‘dead time’. Depending on the particular quenching circuitry implemented, this recovery time may be in the region of a few 10′s of nanoseconds, or longer. For example, for a dead time of 100 nanoseconds, a maximum theoretical photon count per SPAD would be 10⁷ per second.

Saturation may additionally or alternatively occur when circuitry associated with the SPADs, e.g. reading and counting circuitry attached to each SPAD, reaches a limit.

In some examples, every single SPAD has a dedicated read-out bandwidth for registering photon-strike events. This leads to a physical limitation on the maximum measurable signal for a given architecture.

For example, in some examples, every SPAD has only a single latch to store a photon-strike event, e.g. a single-bit counter. This latch may be reset every time it is read. A minimum read-out interval is a time required to read out all of such latches.

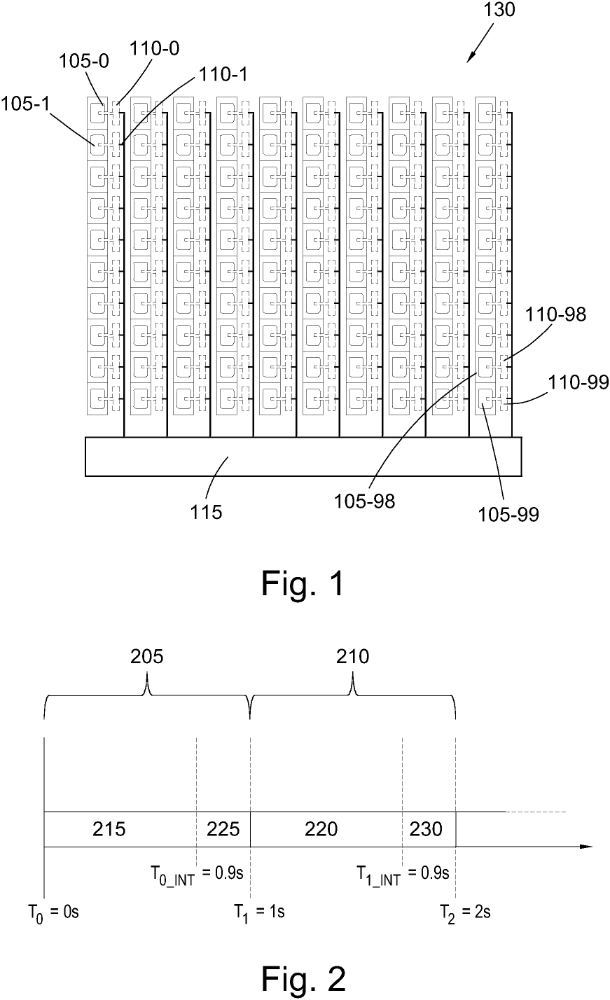

FIG. 1 depicts an example of a SPAD-based sensor architecture 100 comprising 100 SPADs and associated single-bit counters, according to an embodiment of the disclosure. The SPAD-based sensor architecture 100 of FIG. 1 provides an example of the disclosure, namely determining an intensity of incident radiation, using a radiation-sensitive device comprising a plurality of SPADs, wherein circuitry is configured to measure an intensity of incident radiation from the array of SPADs with a plurality of different measurement windows to provide an associated plurality of results. As will be described in more detail below, in some embodiments the circuitry may be configured to determine the intensity of the incident radiation from one of the plurality of results, a selection of the result determined by whether the result exceeds a maximum count. The maximum count may be defined, at least in part, by a duration of the measurement window associated with the result.

It will be appreciated that FIG. 1 is an example embodiment only, and is provided for purposes of explaining the principles of the disclosure. For example, other embodiments may comprise substantially larger arrays of SPADs and associated single-bit counters. For example, some embodiments may comprise arrays having hundreds or even thousands of SPADs. Furthermore, example devices embodying the disclosure, such as sensors suitable for use in PoC or E-nose applications, may comprise multiple arrays of SPADs.

The SPAD-based sensor architecture 100 of FIG. 1 comprises a plurality of SPADs 105-0 to 105-99. For purposes of example only, the SPADs 105-0 to 105-99 are arranged as a 10 × 10 array. Each SPAD of FIG. 1 has an associated single-bit counter 110-0 to 110-99. In some embodiments, the single bit-counters 110-0 to 110-99 may be implemented using latches, switches, or the like.

The single-bit counters 110-0 to 110-99 are depicted as coupled to processing circuitry 115.

Such processing circuitry 115 may be configured to determine an intensity of incident radiation using at least one of the plurality SPADs 105-0 to 105-99, wherein the processing circuitry 115 is configured to measure an intensity of incident radiation from the array of SPADs 105-0 to 105-99 with a plurality of different measurement windows to provide an associated plurality of results,

Embodiments of the disclosure are based on the following principle: when multiple SPADs are used together to measure light intensity, a (statistical) signal-to-noise ratio is proportional to a measurement time window, e.g. an interval, over which the measurement is taken.

As such, embodiments of the disclosure effectively trade off SNR, which is overabundant at high radiation levels, for dynamic range, as described below in more detail. It has been recognised that as an intensity of radiation being measured, i.e. a signal level, decreases, the size of the measurement time window over which the measurement must be taken increases. Conversely, at high levels of intensity of incident radiation, a minimum measurement window may be needed to ensure sufficient SNR.

For a radiation-sensitive device comprising a number of SPADs, “Num_{SPAD}”, and wherein a time required to read-out and reset a latch associated with each SPAD is “T_{1_SPAD}”, a total read-out time of the plurality of SPADs is Num_{SPAD} × T_{1_SPAD}.

However, even though reading out all the SPADs may take a mimimum time Num_{Sp}*T_{1_SPAD}, in the case of a high intensity of incident radiation the SPADs can be kept inactive for a part of this time window.

Considering an example wherein an intensity of the incident radiation increases to a level such that the probability of more than one photon striking a SPAD in the window of “Num_{Sp}*T_{1_SPAD}” becomes relatively high. In such an example, the SPADs may be kept active only for only a fourth of the time window Num_{Sp}*T_{1_SPAD}.

According to a Poissonian statistical nature of photon incidence, the probability of more than one photon striking a SPAD in this time window, and thereby getting missed, is now reduced to near zero.

In such an example, every detected photon would be given a weighting of four to account for the fact that the detection window is only one fourth of the total read-out time.

Embodiments of the disclosure may employ this technique in a non-adaptive way, without requiring any dynamic changes to the operational timings of a device may depend upon an intensity of the incident radiation.

For example, referring again to the example SPAD-based sensor architecture 100 of FIG. 1, there is depicted an array of 100 SPADs 105-0 to 105_99.

With 100 SPADs and a read-out rate of 10 MHz, a time taken to read out the complete array would be 100/10⁶ = 10 microseconds. As such, each SPAD is theoretically capable of detecting 100,000 counts per second.

If, for example, a radiation-sensitive device implementing the SPAD-based sensor architecture 100 of FIG. 1 is configured to operate for the first 0.9 seconds of every second with a measurement window covering the full 10us, every photon detected in this period would be given a weighting of 1.

To extrapolate this number to 1 second, it is multiplied by 1/0.9, since only 0.9 of each second is used. As such, a result with a maximum count of 100,000 is based on this measurement. For purposes of example, this is termed “Result X”.

The radiation-sensitive device may also be configured to operate for the last 0.1 of each second with a measurement window of only 1 us, e.g. only one tenth of the 10 us read-out time. In such an example, a theoretical maximum of 10,000 counts per SPAD per second is achievable, e.g. 0.1/10 microseconds.

Since the SPADs are active only ⅒^{th} of the total time, every photon detected gets 10 times the weighting. Furthermore, to extrapolate this from 0.1 seconds to 1 second, a further factor of 10 is applied. Since a theoretical maximum count of 10,000 can be measured in this 0.1 second, application of the weighting factors effectively translates this to 1,000,000 counts per SPAD per second. For purposes of example, this is termed “Result X”.

Hence, two results may be generated: Result X with a maximum count of 100,000 and Result Y with a maximum count of 1,000,000.

Result Y may be substantially noisier than Result X, because Result Y is based upon an effective time-window of 1/100th of a second. So for signal values below 100000, Result X will be used to determine the intensity of incident radiation. For higher counts, Result Y may be used. This is because, since the intensity of incident radiation is so high, e.g. greater than 100000 counts, the higher noise due to the reduced time window for Result Y becomes irrelevant. That is, there is a sufficient Signal to Noise Ratio.

As such, a selection of the result, e.g. Result X or Result Y, may be determined by whether the results exceed a maximum count. As described above, the maximum count is defined, at least in part, by a duration of the measurement window associated with the result.

Thus, in this example, the disclosed embodiment has enabled the dynamic range of measurement to be increased from 100,000 counts by a factor of 10, to 1,000,000 counts.

In further embodiments of the disclosure, this principle may be extended by providing more steps, e.g. more than just two different measurement windows and associated results.

By progressively using shorter measurement windows, e.g. 1 microsecond, 100 nanoseconds and then 10 nanoseconds, increasingly higher levels of incident radiation can be detected. For example, a 10 nanosecond measurement window may be used for 1/100^{th} of a second. Each 10 nanosecond SPAD measurement window is inside a 10 microsecond read-out time. As such, every photon detected gets a weighting of 10 nanoseconds/10 microsecond * 100 = 100,000. The number of read cycles is (1/100^{th} of a second)/10 microsecond = 1000. As such, the maximum effective photon count possible would be 1000 * 100,000 = 10⁸.

The above-described example illustrates how embodiments of the disclosure may enable a dynamic range extension that extends beyond a maximum radiation detection level limit that may be imposed by the “Dead Time” of SPADs.

For example, a SPAD-based sensor architecture comprising counters (of a theoretically unlimited size) connected to every SPAD would still be limited to a maximum detectable radiation intensity level by the time taken by a SPAD to recover from a trigger and become ready for the next detection For example, if the dead time is 100 ns, a given SPAD can only detect a max of 1/100 ns = 10e7 photons per second. However, the disclosed embodiments enable application of a measurement window smaller than 100 ns. As such, a limit imposed by a dead-time may be exceeded as described in the example above, wherein a 10 ns measurement window would raises the limit to 10e8 photons per second.

In one embodiment, the measurement windows may reduce in duration by a factor of four for every factor of two increase in an intensity of the incident radiation, e.g. every factor of two increase in the count.

It will be appreciated that the above-described embodiments may also overcome a limit set by a SPAD dead time. For example, the fastest rate at which a SPAD-based device can count photon-strike events is determined by a time between a photon-strike event and a recovery time of the SPAD. The recovery time is a time required for a given SPAD to recover and be ready again. This is known in the art as the ‘dead time’. Depending on the particular quenching circuitry implemented, this recovery time may be in the region of a few 10′s of nanoseconds, or longer. For example, for a dead time of 100 nanoseconds, a maximum theoretical photon count per SPAD would be 10⁷ per second.

In the example of a SPAD dead time of 100 ns, the measurement window of the SPADs may be reduced to, for example, 50 nanoseconds only. The probability that a SPAD is triggered in this measurement window remains very low until the light density is close to 1 photon (after taking the quantum efficiency and area utilization into account) per 50 nanoseconds. Thus, embodiments of the disclosure are effectively able to detect radiation at double the level of the limit set by the SPAD dead time.

In some embodiments, this principle may be extended to as high a value as corresponding to the smallest controllable measurement window, for example 10 nanoseconds. That is, with a measurement window of 10 nanoseconds and a dead time of 100 nanoseconds, it would be possible to detect a radiation value 10 times higher than a limit set by the SPAD dead time.

FIG. 2 depicts example measurement periods of a radiation-sensitive device according to an embodiment of the disclosure.

In FIG. 2 a first measurement period 205 commences at time T₀ = 0 s. Each measurement period lasts for 1 second. As such, a second measurement period 210 commences at T₁ = 1 second, and so on.

Continuing with the above-described example of a 100 SPAD array with a read-out rate of 10 MHz and thus a time of 10 microseconds to read-out the entire array, in a first portion 215, 220 of each measurement period 205, 210 a measurement window covering the full 10 microseconds is used. The first portion 215 of the first measurement period 205 extends from T₀ = 0 seconds to T_{0_INT} = 0.9 seconds. Similarly, a first portion 220 of the second measurement period 210 extends from T₁ = 1 seconds to T_{1_INT} = 1.9 seconds, and so on.

As described above, every photon detected in the first portion 215, 220 of each measurement period 205, 210 given a weighting of 1. To extrapolate this number to 1 second, it is multiplied 1/0.9, since only 0.9 seconds of each second is used. As such, a result with a maximum count of 100,000 is based on this measurement.

In a second portion 225, 230 of each measurement period 205, 210 a measurement window covering the just 1 microsecond is used. The second portion 225 of the first measurement period 205 extends from T_{0_}_{INT} = 0.9 seconds to T₁ = 1 seconds. Similarly, a second portion 230 of the second measurement period 210 extends from T_{1_INT} = 1.9 seconds to T₂ = 2 seconds, and so on.

As described above, since the SPADs are active only ⅒^{th} of the total time in the second portion 225, 230 of each measurement period 205, 210, every photon detected gets 10 times the weighting. Furthermore, to extrapolate this from 0.1 seconds to 1 second, a further factor of 10 is applied. Since a theoretical maximum count of 10,000 can be measured in this 0.1 sec, application of the weighting factors effectively translates this to 1,000,000 counts per SPAD per second.

That is, the array of SPADs to measure the incident radiation with a relatively short measurement window for a smaller portion, e.g. second portion 225, 230, of the measurement period 205, 210 than a portion, e.g. first portion 215, 220, of the measurement period 205, 210 that the array of SPADs measures the incident radiation with a relatively long measurement window.

In some embodiments, a duration of the measurement window in each consecutive portion of a measurement period may be increased or decreased by a factor of four for every factor of two increase in a signal, e.g. an increase in an intensity of the incident radiation.

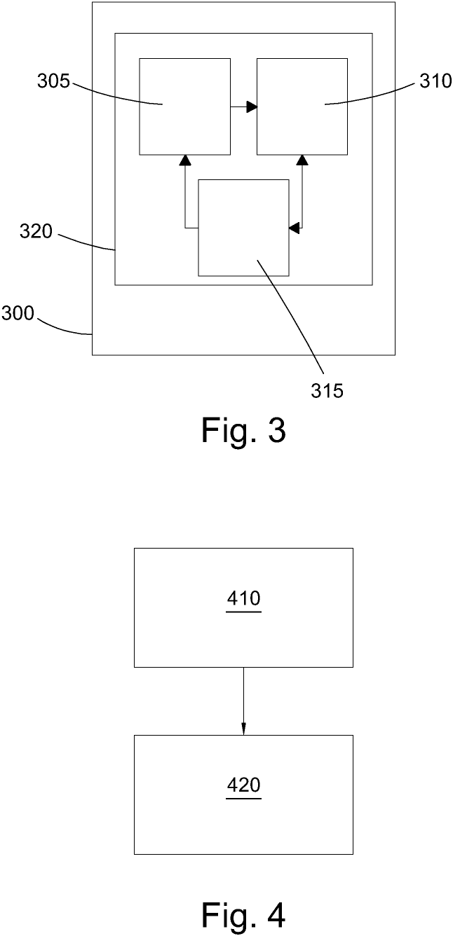

FIG. 3 depicts an apparatus 300 comprising a radiation-sensitive device 320 according to an embodiment of the invention. In some example embodiments, the apparatus 300 may be an apparatus for a Point of Care (PoC) testing or Electronic-Nose (E-nose) type of application, or an ambient radiation sensor application.

The radiation-sensitive device 320 comprises a plurality of SPADs 305. The plurality of SPADs 305 may be arranged as one or more arrays of SPADs 305.

The radiation-sensitive device 320 also comprises a plurality of single-bit counters 310, e.g. latches. Each single-bit counter of the plurality of single-bit counters 310 is associated with a SPAD of the plurality of SPADs 305, as described above with reference to FIG. 1. The SPADs 305 and the associated single-bit counters 310 may be arranged in accordance with SPAD-based sensor architecture 100 of FIG. 1.

The radiation-sensitive device 320 also comprises processing circuitry 315. In some embodiments, the processing circuitry 315 may be configured to control the plurality of SPADs 305. For example, in some embodiments the processing circuitry 315 may be configured to control quenching of the SPADs 305, and or reset or enabling of one or more of the SPADs 305. The processing circuitry 315 may also be configured to detect one or more faulty SPADs 305.

In some embodiments, the processing circuitry 315 may be configured to read the single-bit counters 310. In some embodiments, the processing circuitry 315 may also be configured to reset the single-bit counters 310 as required. The processing circuitry 315 may comprise at least one of: a CPU, a microcontroller, a state machine, combinatorial logic, or the like.

In some embodiments, the processing circuitry 315 may be configured to determine an intensity of incident radiation from the array of SPADs with a plurality of different measurement windows to provide an associated plurality of results, wherein the processing circuitry 315 is configured to determine the intensity of the incident radiation from one of the plurality of results, a selection of the result determined by whether the result exceeds a maximum count defined, at least in part, by a duration of the measurement window associated with the result.

In some embodiments, an aperture, a lens, an optical cover, a grating or one or more other optical devices may be disposed between the SPADs 305 and a source of radiation. Such devices may, for example, be configured to focus and/or diffuse radiation incident upon the SPADs 305. In some embodiments, one or more apertures may be stacked to form a stack of shifted apertures, or pin-holes. Such a stack may be disposed on or in close proximity to the SPADs 305. In such embodiments, at least some of the SPADs 305 may be subjected to a lower intensity of incident radiation than other SPADs of the radiation-sensitive device 320. By using such shifted apertures, in combination with any of the above-described techniques, a dynamic range of the radiation-sensitive device 320 may be further increased.

FIG. 4 depicts a method of increasing a dynamic range of a radiation-sensitive device comprising an array of SPADs. The method comprising a first step 410 comprising measuring an intensity of incident radiation from the array of SPADs with a plurality of different measurement windows to provide an associated plurality of results.

The method comprises a second step 420 of determining the intensity of the incident radiation from one of the plurality of results, a selection of the result determined by whether the result exceeds a maximum count defined, at least in part, by a duration of the measurement window associated with the result.

Although the disclosure has been described in terms of particular embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

1. A radiation-sensitive device comprising:
an array of single photon avalanche diodes (SPADs) ; and
circuitry configured to measure an intensity of incident radiation from the array of SPADs with a plurality of different measurement time windows during which the SPADs are active to provide an associated plurality of results,
wherein the circuitry is configured to determine the intensity of the incident radiation from one of the plurality of results, a selection of the result determined by
the result not exceeding a maximum count associated with a measurement time window and defined, at least in part, by a duration of the measurement time window associated with the result.

2. A radiation-sensitive device of claim 1, wherein the circuitry is configured to scale at least one result with a corresponding weighting factor, a magnitude of the weighting factor corresponding to the duration of the measurement window associated with the result.

3. A radiation-sensitive device of claim 1, wherein the maximum count is defined by the duration of the measurement window associated with the result and a read-out rate of the SPADs .

4. A radiation-sensitive device of claim 1, wherein a duration of the measurement window in each consecutive portion of a measurement period varies by a factor of four.

5. A radiation-sensitive device of claim 1, wherein the circuitry is configured to configure the array of SPADs to measure the incident radiation with a relatively short measurement window for a smaller portion of a/the measurement period than a portion of the measurement period that the array of SPADs measures the incident radiation with a relatively long measurement window.

6. A radiation-sensitive device of claim 1, wherein a duration of each measurement window is programmable.

7. A radiation-sensitive device of claim 1, a duration of each portion of a/the measurement period is programmable, wherein a duration of the measurement window is different in each portion of the measurement period.

8. A radiation-sensitive device of claim 1, wherein each SPAD of the plurality of SPADs has an associated single-bit counter for registering photon strikes.

9. A method of increasing a dynamic range of a radiation-sensitive device comprising an array of SPADs, the method comprising:
measuring an intensity of incident radiation from the array of SPADs with a plurality of different measurement windows to provide an associated plurality of results;
determining the intensity of the incident radiation from one of the plurality of results, a selection of the result determined by whether the result exceeds a maximum count defined, at least in part, by a duration of the measurement window associated with the result.

10. The method of claim 9, comprising a step of selecting and/or programming a duration of each measurement window of the plurality of measurement windows.

11. The method of claim 9, wherein the step of measuring the intensity of incident radiation from the array of SPADs with a plurality of different measurement windows comprises using a relatively short measurement window for a smaller portion of a measurement period than a portion of the measurement period having a relatively long measurement window.

12. The method of claim 9, comprising a step of selecting and/or programming a duration of a portion of the measurement period associated with each measurement window.

13. A method of using a radiation-sensitive device according to claim 1 in a point-of-care testing or diagnostics application, or an electronic-nose application, to determine an intensity of luminescence and/or fluorescence from a specimen.

14. An electronic-nose or point-of-care apparatus comprising a radiation-sensitive device according to claim 1, wherein the radiation-sensitive device is configured to determine an intensity of luminescence and/or fluorescence from a specimen.

15. A method of using a radiation-sensitive device according to claim 1 in an ambient radiation sensing application.
